(19) United States
(12) Patent Application Publication
(10) Pub. No.: US 2025/0225561 A1
(43) Pub. Date: Jul. 10, 2025

(54) COMPATIBLE PRODUCT RECOMMENDATIONS

(71) Applicant: Motorola Mobility LLC, Chicago, IL (US)

(72) Inventors: Krishnan Raghavan, Bangalore (IN); Vijayprakash Idlur, Bengaluru (IN); A G Prasad, Bengaluru (IN)

(73) Assignee: Motorola Mobility LLC, Chicago, IL (US)

(21) Appl. No.: 18/406,964

(22) Filed: Jan. 8, 2024

(51) Int. Cl. G06Q 30/0601; G06Q 30/0282

(52) U.S. Cl. CPC G06Q 30/0631; G06Q 30/0282; G06Q 30/0623; G06Q 30/0639; G06Q 30/0641

(57) ABSTRACT

In aspects of compatible product recommendations, a mobile device implements a product recommendation manager that receives a search input for a consumer product. The product recommendation manager receives a recommendation list of compatible products with the consumer product. The compatible products can be determined based at least in part on a profile associated with the mobile device and product feedback corresponding to returned products. The product recommendation manager can then display the recommendation list of the compatible products on a display device. In implementations, a server device determines the profile associated with the mobile device, and generates the recommendation list of the compatible products with the consumer product.

### BACKGROUND

Devices such as smart devices, mobile devices (e.g., cellular phones, tablet devices, smartphones), consumer electronics, and the like can be implemented for use in a wide range of environments and for a variety of different applications. For example, a device can access an e-commerce application, such as a marketplace application that allows a user of the device to purchase items. Shopping online is a convenient method for many people to purchase items. The marketplace application can include a user interface for displaying products to the user, and the user may interact with the user interface to purchase products. The marketplace application may also suggest products to the user based on the user interaction with the marketplace. Many of the people who are consumers using marketplace applications for shopping live in housing complexes with multiple units, such as apartments, condos, town houses, etc. Most of these types of multiple unit housing complexes have the same or very similar appliances, layouts, fixtures, etc., and many of the appliances and fixtures, for example, are sized specifically for the particular layout of a multiple unit housing complex. When an appliance or fixture fails, the people (e.g., consumers) living in these multiple unit housing complexes need to be able to identify and purchase a replacement product that is compatible with the layout constraints and fitment in the allotted space of a person's particular housing unit.

### BRIEF DESCRIPTION OF THE DRAWINGS

Implementations of the techniques for compatible product recommendations are described with reference to the following Figures. The same numbers may be used throughout to reference like features and components shown in the Figures.

FIG. 1 illustrates an example system for compatible product recommendations in accordance with one or more implementations as described herein.

FIG. 2 further illustrates an example system for compatible product recommendations in accordance with one or more implementations as described herein.

FIG. 3 illustrates an example system and procedure in which aspects of compatible product recommendations can be implemented to generate a compatible product recommendation.

FIG. 4 illustrates an example device for compatible product recommendations in accordance with one or more implementations as described herein.

FIGS. 5-7 illustrate methods for compatible product recommendations in accordance with one or more implementations of the techniques described herein.

FIG. 8 illustrates various components of an example device that may be used to implement the techniques for compatible product recommendations as described herein.

### DETAILED DESCRIPTION

Implementations of the techniques for compatible product recommendations may be implemented as described herein. A mobile device, such as any type of a wireless device, media device, mobile phone, flip phone, client device, tablet, computing, communication, entertainment, gaming, media playback, and/or any other type of computing, consumer, and/or electronic device, or a system of any combination of such devices, may be configured to perform techniques for compatible product recommendations as described herein. In one or more implementations, a mobile device includes a product recommendation manager, which can be used to implement aspects of the techniques described herein. Further, a server device includes a product recommendation engine, which can be used to implement aspects of the techniques described herein. In one or more devices and/or services, the product recommendation manager and/or the product recommendation engine can be implemented using a machine learning model or algorithm (e.g., a neural network, AI algorithms) to determine and generate a recommendation list with compatible products.

Conventional techniques for consumer product suggestions include suggesting products based on a variety of aspects, including bestseller products, popular products, deals and discounts, ratings, user behavior, and demographics. However, many people live in housing complexes with multiple units, such as apartments, condos, town houses, etc. Most of the multiple unit housing complexes have the same or very similar appliances, layouts, fixtures, etc., and many of the appliances and fixtures, for example, are sized specifically for the particular layout of a multiple unit housing complex. For consumers living in these multiple unit housing complexes, when an appliance or fixture fails, the consumer needs to be able to identify and purchase a replacement product that is compatible with the layout constraints and fitment in the allotted space of a person's particular housing unit. Conventional techniques for consumer product suggestions fail to consider installation location, which results in ill-suited recommendations.

In aspects of the described techniques, the product recommendation manager implemented by a mobile device can receive a search input for a consumer product. The consumer product may be a household product such as furniture, kitchen appliances, home decor items, lighting fixtures, bathroom accessories, home improvement tools, small household appliances, and/or any type of items for sale that may require installation, fitment, and/or operational compatibility, such as an appliance. Notably, an appliance purchased for installation in a small apartment unit is likely smaller with different connections (e.g., power, water, and the like) and/or connection locations and fitment than a similar appliance purchased for use in a home or larger residence. The search input can be communicated to a server device that implements the product recommendation engine. The product recommendation engine can then generate a recommendation list of compatible products. The compatible products may be compatible models, brands, manufacturers, different years of manufacturer, different versions, types, designs, variety, etc., that will satisfy installation, fitment, and/or operational compatibility for the consumer.

The compatible products may be included on the recommendation list if a compatible product was previously purchased by a different consumer or consumers with similar compatibility issues, and the product was not returned. Similar compatibility issues may be determined based on location information within a profile that is associated with the mobile device of the consumer, and with product purchaser profiles. The profile associated with the mobile device can include a location indication, a building/unit identifier, and/or any other type of user and/or device profile information. The product purchaser profiles may also include a location indication, a building/unit identifier, and/or any other type of profile information. In implementations, the product recommendation engine can generate the recommendation list of compatible products based on the search input from the consumer, the profile associated with the mobile device, the product purchaser profiles, and a building/unit identifier.

In other aspects of the described techniques, the product recommendation engine can identify product feedback associated with the product purchaser profiles. For example, consumers may leave product reviews, and the product recommendation engine can extract the product feedback from the product reviews and determine the identified compatible products of the recommendation list based on the product feedback. In addition to positive feedback, product feedback may also include negative feedback, which indicates reasons the product is not compatible with a particular location. Negative product feedback may include reasons for returning the product, such as the product does not fit, different types of connections, connection location is improper, operational limitations, installation and fitment problems, and/or any other reason the product is incompatible. Product feedback may also include positive feedback which indicates reasons the product is compatible with a particular location. Positive feedback may include reasons for installing the product, for example, the product fits and is installable, adequate connections, suitable location, and/or any other reason the product is compatible. The product recommendation engine can also be used to generate a negative product list of products associated with negative feedback and/or generate a positive product list with compatible products associated with the positive feedback. The product recommendation engine can compare the negative product list to the positive product list and filter out products based on product criteria of the search input. Through the filtering process the product recommendation engine can identify the compatible products that are compiled into the recommendation list for display to the consumer, such as on an e-commerce webpage displayed on the consumer's mobile device.

While features and concepts of the described techniques for compatible product recommendations is implemented in any number of different devices, systems, environments, and/or configurations, implementations of the techniques for compatible product recommendations are described in the context of the following example devices, systems, and methods.

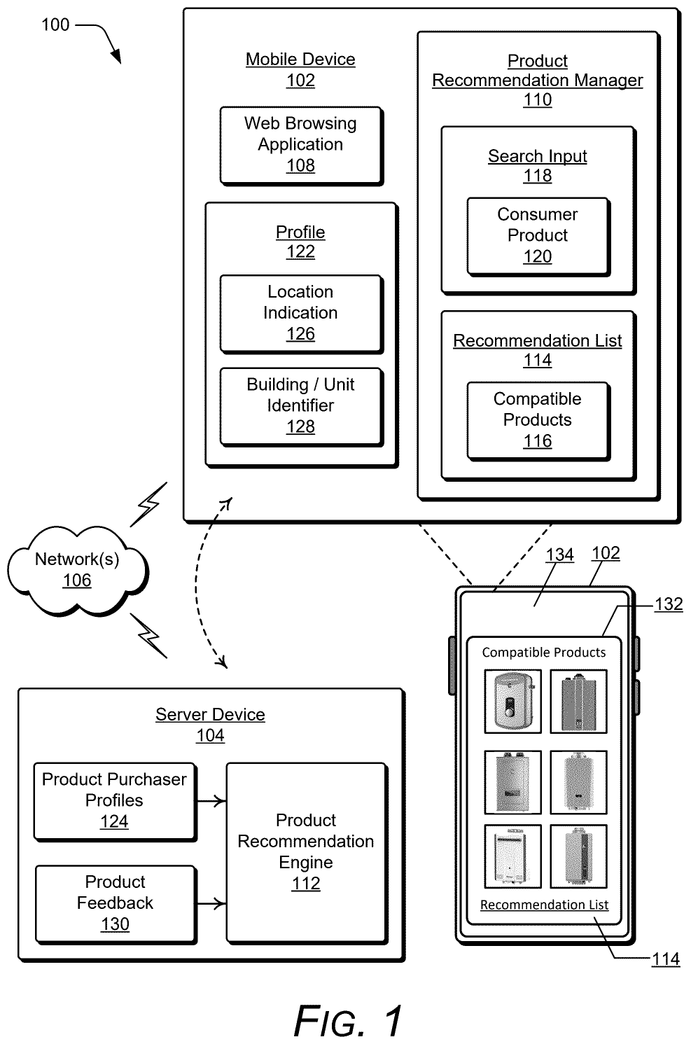

FIG. 1 illustrates an example system 100 for compatible product recommendations, as described herein. The system 100 includes a mobile device 102, a server device 104, and a communication network 106. Examples of the mobile device 102 include any type of a wireless device, mobile device, mobile phone, flip phone, client device, companion device, tablet, computing device, communication device, entertainment device, gaming device, media playback device, and/or any other type of computing, consumer, and/or electronic device.

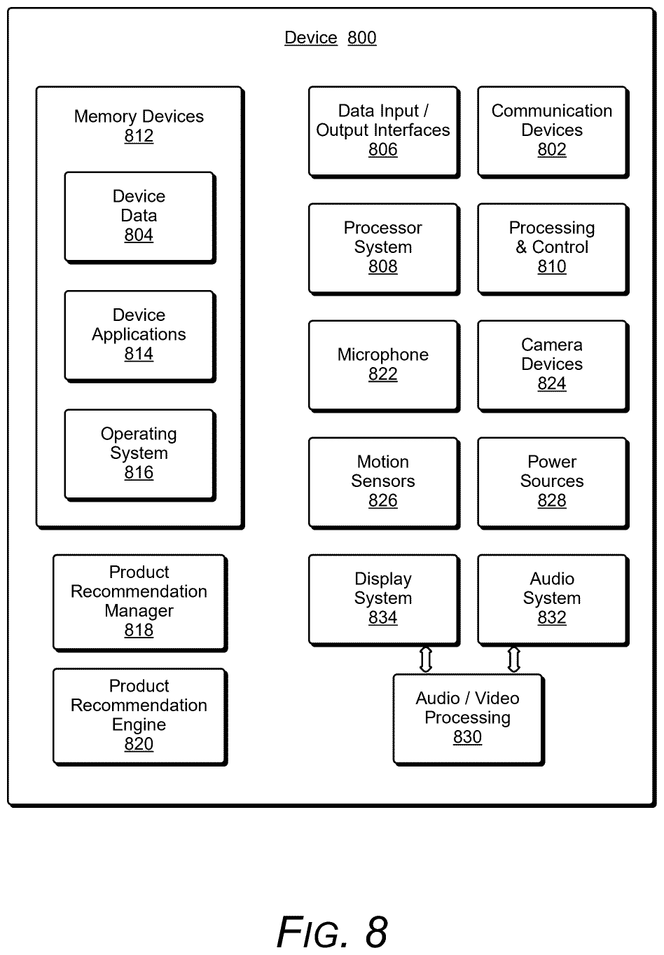

The mobile device 102 can be implemented with various components, such as a processor system and memory, as well as any number and combination of different components as further described with reference to the example device shown in FIG. 8. In implementations, the mobile device 102 includes various radios for wireless communication with other devices. For example, the mobile device 102 can include at least one of a Bluetooth (BT) and/or Bluetooth Low Energy (BLE) transceiver, as well as a near field communication (NFC) transceiver, or the like. In some cases, the mobile device 102 includes at least one of a WiFi radio, a cellular radio, a global positioning satellite (GPS) radio, or any available type of device communication interface. Similarly, the server device 104 can be implemented with various components, such as a processor system and memory, as well as any number and combination of different components as further described with reference to the example device shown in FIG. 8.

In some implementations, the devices, applications, modules, servers, and/or services described herein communicate via the communication network 106, such as for data communication with the mobile device 102 and/or the server device 104. The communication network 106 includes a wired and/or a wireless network. The communication network 106 can be implemented using any type of network topology and/or communication protocol, and is represented or otherwise implemented as a combination of two or more networks, to include IP-based networks, cellular networks, and/or the Internet. The communication network 106 can also include mobile operator networks that are managed by a mobile network operator and/or other network operators, such as a communication service provider, mobile phone provider, and/or Internet service provider.

The mobile device 102 includes various functionality that enables the device to implement different aspects of compatible product recommendations, as described herein. In one or more examples, an interface module represents functionality (e.g., logic and/or hardware) enabling the mobile device 102 to interconnect and interface with other devices and/or networks, such as the server device 104 via the communication network 106. For example, an interface module enables wireless and/or wired connectivity of the mobile device 102. Similarly, the server device 104 includes various functionality that enables the device to implement different aspects of compatible product recommendations, as described herein.

The mobile device 102 can include and implement various device applications, such as any type of a web browsing application 108, messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102. Generally, an application user interface, or any other type of video, image, graphic, and the like is digital image content that is displayable on the display screen of the mobile device 102. Generally, the web browsing application 108 may be any type of internet browser and/or any other application that connects to an e-commerce webpage via the mobile device 102 or the server device 104.

In the example system 100 for compatible product recommendations, the mobile device 102 implements a product recommendation manager 110 (e.g., may be a device application implemented as software). As shown in this example, the product recommendation manager 110 represents functionality (e.g., logic, software, and/or hardware) enabling aspects of the described techniques for compatible product recommendations. The product recommendation manager 110 can be implemented as computer instructions stored on computer-readable storage media and can be executed by a processor system of the mobile device 102. Alternatively, or in addition, the product recommendation manager 110 can be implemented at least partially in hardware of the device.

In one or more implementations, the product recommendation manager 110 includes independent processing, memory, and/or logic components functioning as a computing and/or electronic device integrated with the mobile device 102. Alternatively, or in addition, the product recommendation manager 110 can be implemented in software, in hardware, or as a combination of software and hardware components. In this example, the product recommendation manager 110 is implemented as a software application or module, such as executable software instructions (e.g., computer-executable instructions) that are executable with a processor system of the mobile device 102 to implement the techniques and features described herein. As a software application or module, the product recommendation manager 110 can be stored on computer-readable storage memory (e.g., memory of a device), or in any other suitable memory device or electronic data storage implemented with the controller. Alternatively or in addition, the product recommendation manager 110 is implemented in firmware and/or at least partially in computer hardware. For example, at least part of the product recommendation manager 110 is executable by a computer processor, and/or at least part of the content manager is implemented in logic circuitry.

In one or more implementations, the product recommendation manager 110 is implemented using a machine learning (ML) model or algorithm (e.g., a neural network, artificial intelligence (AI) algorithms). The product recommendation manager 110 implemented as a machine learning model may include AI, a ML model or algorithm, a convolutional neural network (CNN), and/or any other type of machine learning model to display compatible product recommendations. As used herein, the term “machine learning model” refers to a computer representation that is trainable based on inputs to approximate unknown functions. For example, a machine learning model can utilize algorithms to learn from, and make predictions on, inputs of known data (e.g., training and/or reference images) by analyzing the known data to learn to generate outputs.

In the example system 100 for compatible product recommendations, the server device 104 implements a product recommendation engine 112 (e.g., may be a device application on the server). As shown in this example, the product recommendation engine 112 represents functionality (e.g., logic, software, and/or hardware) enabling aspects of the described techniques for compatible product recommendations. The product recommendation engine 112 can be implemented as computer instructions stored on computer-readable storage media and can be executed by a processor system of the server device 104. Alternatively, or in addition, the product recommendation engine 112 can be implemented at least partially in hardware of the device.

In one or more implementations, the product recommendation engine 112 includes independent processing, memory, and/or logic components functioning as a computing and/or electronic device integrated with the server device 104. Alternatively, or in addition, the product recommendation engine 112 can be implemented in software, in hardware, or as a combination of software and hardware components. In this example, the product recommendation engine 112 is implemented as a software application or module, such as executable software instructions (e.g., computer-executable instructions) that are executable with a processor system of the server device 104 to implement the techniques and features described herein. As a software application or module, the product recommendation engine 112 can be stored on computer-readable storage memory (e.g., memory of a device), or in any other suitable memory device or electronic data storage implemented with the controller. Alternatively or in addition, the product recommendation engine 112 is implemented in firmware and/or at least partially in computer hardware. For example, at least part of the product recommendation engine 112 is executable by a computer processor, and/or at least part of the content manager is implemented in logic circuitry.

In one or more implementations, and similar to the product recommendation manager 110, the product recommendation engine 112 can be implemented using a machine learning model or algorithm (e.g., a neural network, AI algorithms) that can generate a recommendation list 114 of compatible products 116. The product recommendation engine 112 implemented as a machine learning model may include AI, an ML model or algorithm, a CNN, and/or any other type of machine learning model to generate the recommendation list 114 of compatible products 116.

In this example system 100, the product recommendation manager 110 at the mobile device 102 can receive a search input 118 for a consumer product 120. The consumer product 120 may be a household product such as furniture, kitchen appliances, home decor items, lighting fixtures, bathroom accessories, home improvement tools, small household appliances, and/or any type of items for sale that may require installation, fitment, and/or operational compatibility, such as an appliance. Notably, an appliance purchased for installation in a small apartment unit is likely smaller with different connections (e.g., power, water, and the like) and/or connection locations and fitment than a similar appliance purchased for use in a home or larger residence.

In implementations of compatible product recommendations, as described herein, the search input 118 is received by the product recommendation engine 112 at the server device 104, such as an input from a person (e.g., a consumer) who is searching for the consumer product via a user interface on the mobile device 102. For example, the consumer may need to purchase a new water heater for their apartment, specifically a tankless water heater that is compatible with the installation space and location in the apartment. In this example, the consumer may input tankless water heater as the search input 118 at the mobile device 102, and the search input is communicated to the product recommendation engine 112. The product recommendation engine 112 can then generate the recommendation list 114 of the compatible products 116. The compatible products 116 may be compatible models, brands, manufacturers, different years of manufacturer, different versions, types, designs, variety, etc., that will satisfy installation, fitment, and/or operational compatibility for the consumer.

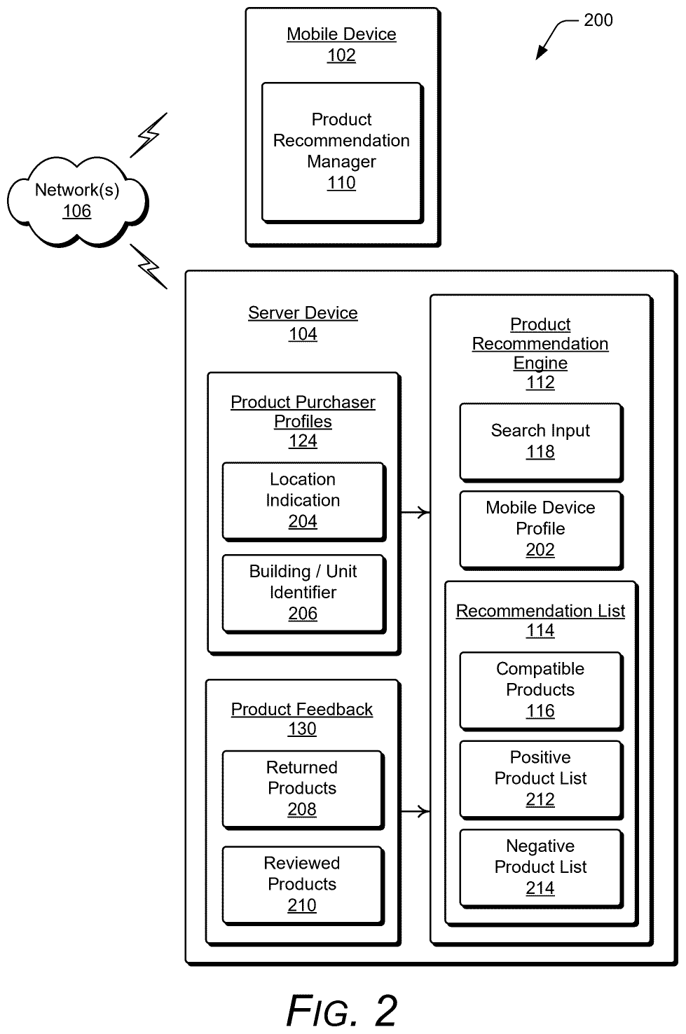

For example the recommendation list 114 of the compatible products 116 for the tankless water heater search input may include various manufactures and models of tankless water heaters that are compatible with the installation fitment and location in a consumer's housing unit. The compatible products 116 may be included on the recommendation list 114 if a compatible product was previously purchased by a different consumer or consumers with similar compatibility issues, and the product was not returned. Similar compatibility issues may be determined based at least in part on location information within a profile 122 associated with the mobile device 102 and product purchaser profiles 124. The profile 122 associated with the mobile device 102 can include a location indication 126, a building/unit identifier 128, and/or any other type of user and/or device profile information. The product purchaser profiles 124 may also include a location indication, a building/unit identifier, and/or any other type of profile information, as further described with reference to FIG. 2.

The product recommendation engine 112 can generate the recommendation list 114 of compatible products based on the search input 118, the profile 122 associated with the mobile device 102, the product purchaser profiles 124, and the building/unit identifier 128. In implementations, the product feedback 130 may include product reviews, ratings, reasons for returns, and/or any other product-related comments. Additionally, the product recommendation engine 112 can sort through the product feedback 130, display relevant comments associated with the compatible products 116, and extract product ratings to display highly rated compatible products 116. The product recommendation engine 112 can generate the recommendation list 114 based on the foregoing and as further described with reference to FIG. 2.

The recommendation list 114 can be displayed within an e-commerce webpage 132 on a user interface 134 that is displayed on a display device of the mobile device 102. The e-commerce webpage 132 may be any online marketplace and/or any other website selling consumer goods. The recommendation list 114 can include product images, descriptions, prices, ratings, reviews, specifications, and/or any other relevant information associated with the compatible products 116.

In implementations of compatible product recommendations, as described herein, the server device 104 can receive, collect, store, and/or communicate the recommendation list 114 in response to the search input 118 received at the mobile device 102. The server device 104 identifies the profile 122 associated with the mobile device 102 and product purchaser profiles 124, and communicates profile information to the product recommendation engine 112. The product recommendation engine 112 can compare profile location information to identify product purchaser profiles with compatible location information to the profile 122 associated with the mobile device 102. For example, the product recommendation engine 112 can determine that the location indication 126 associated with the profile 122 of the mobile device 102 corresponds to the location information associated with the product purchaser profiles 124. The location indication and information may correspond when a building/unit identifier 128 is similar, or the location is otherwise found to be similar. As noted above, many people who are consumers using marketplace applications for shopping live in housing complexes with multiple units, such as apartments, condos, town houses, etc. Most of these types of multiple unit housing complexes have the same or very similar appliances, layouts, fixtures, etc., and many of the appliances and fixtures, for example, are sized specifically for the particular layout of a multiple unit housing complex.

Additionally, the product recommendation engine 112 can identify product feedback 130 associated with the product purchaser profiles 124. For example, consumers may leave product reviews, which may be saved with the associated product purchaser profiles 124. Further, the product recommendation engine 112 can extract the product feedback 130 from the product reviews and/or the identified product purchaser profiles 124 and base the identified compatible products 116 of the recommendation list 114 on the product feedback 130. In addition to positive feedback, product feedback may also include negative feedback, which indicates reasons the product is not compatible with a particular location. Negative product feedback may include reasons for returning the product, such as the product does not fit, different types of connections, connection location is improper, operational limitations, installation and fitment problems, and/or any other reason the product is incompatible. Product feedback may also include positive feedback which indicates reasons the product is compatible with a particular location. Positive feedback may include reasons for installing the product, for example, the product fits and is installable, adequate connections, suitable location, and/or any other reason the product is compatible. The product recommendation engine 112 can also be used to generate a negative product list of products associated with negative feedback and/or generate a positive product list with compatible products associated with the positive feedback.

Further, the product recommendation engine 112 may search and filter the product feedback described above to generate the recommendation list 114. For example, the product recommendation engine 112 can compare the negative product list to the positive product list and filter out products based on the search input 118. Through the filtering process the product recommendation engine 112 may identify the compatible products 116, and the compatible products are compiled into the recommendation list for display on the e-commerce webpage 132.

FIG. 2 illustrates example 200 of compatible product recommendations, as described herein. Generally, the example 200 includes the mobile device 102, the server device 104, and the network 106 which can be utilized to implement features and techniques of compatible product recommendations, such as shown and described with reference to FIG. 1. In this example 200, the mobile device 102 may communicate information with the server device 104 over the network 106. The mobile device 102 is implemented with the product recommendation manager 110, such as shown and described with reference to FIG. 1. As shown in this example 200, the product recommendation manager 110 represents functionality (e.g., logic, software, and/or hardware) enabling aspects of the described techniques for compatible product recommendations.

In one or more implementations, the product recommendation engine 112 implemented at the server device 104 can receive, collect, store, and/or communicate the search input 118 for the consumer product 120, as received from the product recommendation manager 110 of the mobile device 102. The search input 118 may be for the consumer product 120 as described with reference to FIG. 1. The product recommendation engine 112 can obtain or identify a mobile device profile 202 that describes location information associated with the mobile device 102 in response to receiving the search input 118. The location information associated with mobile device profile 202 may include a location indication 126 and/or the building/unit identifier 128.

Additionally, the product recommendation engine 112 can identify the product purchaser profiles 124, such as in response to receiving the search input 118. The product purchaser profiles 124 may be profiles associated with consumers that purchased products related to the search input 118. Additionally, the product purchaser profiles 124 may include location information such as a location indication 204 and/or a building/unit identifier 206, which can be extracted by the product recommendation engine 112 to generate the recommendation list 114. Further, the product recommendation engine 112 can compare the mobile device profile 202 with the product purchaser profiles 124 to identify the product purchaser profiles 124 with compatible location information corresponding to the mobile device profile 202. For example, the product recommendation engine 112 may determine that the location information associated with the mobile device profile 202 corresponds to the location information associated with the product purchaser profiles 124. The location indication and information may correspond when a building/unit identifier is similar, or the location is otherwise found to be similar.

In one or more implementations, the product recommendation engine 112 can extract the product feedback 130 from the compatible products 116 related to the search input 118. The product feedback 130 may include returned products 208 and reviewed products 210. Returned products 208 may be products that were not retained by the product purchaser for any number of reasons, including the product does not fit, different types of connections, connection location is improper, and/or any other reason the product is incompatible. Reviewed products 210 may include product feedback as described with reference to FIG. 1 and/or any number of reasons the product purchaser may be returning or not returning a product.

In one or more implementations, the product recommendation engine 112 can generate a positive product list 212 and/or a negative product list 214 as shown and described with reference to FIG. 1. The product recommendation engine 112 can generate the negative product list 214 to include the returned products 208 and/or any other products determined to be incompatible with product criteria of the search input 118. The product recommendation engine 112 can generate the positive product list 212 with the reviewed products 210 determined to be compatible with the product criteria of the search input 118. The product recommendation engine 112 can compare the negative product list 214 to the positive product list 212 and filter out products based on the search input 118. Through the filtering process the product recommendation engine 112 can identify the compatible products 116. The compatible products 116 can be compiled into the recommendation list 114 for display on the mobile device 102 as shown and described with reference to FIG. 1.

The compatible products 116 may be compatible models, brands, manufacturers, different years of manufacturer, different versions, types, designs, variety, etc., that will satisfy installation, fitment, and/or operational compatibility for a consumer, such as described with reference to FIG. 1. For example, the product recommendation engine 112 may receive the search input 118 for a water heater. The product recommendation engine 112 can compare the location indication 126 associated with the mobile device profile 202 with the location indication 204 associated with the product purchaser profiles 124 to determine whether the location indication 126 and location indication 204 are at least approximately the same location. If the product recommendation engine 112 identifies one or more of the product purchaser profiles 124 that match the mobile device profile 202, the product recommendation engine sorts through the product feedback 130 and generates the recommendation list 114. The recommendation list 114 can be displayed within the e-commerce webpage 132 on the display device of the mobile device 102.

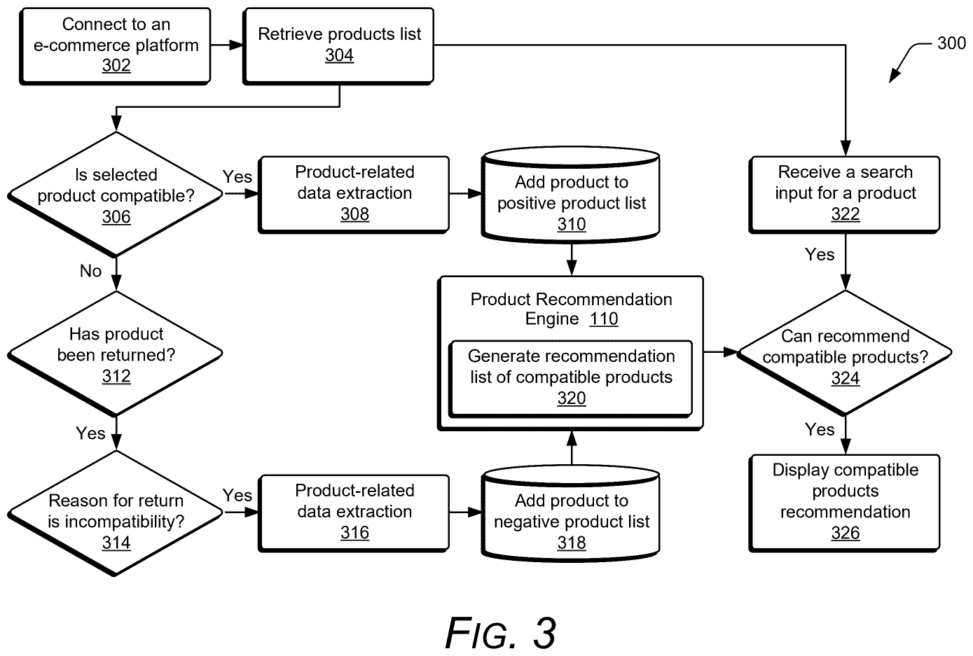

FIG. 3 illustrates an example system and procedure 300 for compatible product recommendations, and the example system and procedure includes aspects of the product recommendation engine 112 implemented by the server device 104. Initially, a connection to an e-commerce platform is established (at 302). For example, the mobile device 102 can connect to the e-commerce webpage 132 so that a consumer may search for and/or purchase a product. Additionally, a products list is retrieved (at 304). For example, products available on the e-commerce webpage 132 are retrieved in response to the search input 118.

At 306, a determination is made as to whether the products within the retrieved products list are compatible. For example, the product recommendation engine 112 can identify a compatible product 116 if the product is retained by one or more of the product purchaser profiles 124 and the location information associated the mobile device profile 202 matches the location information associated with the product purchaser profiles 124 (e.g., “Yes” from 306). If the product recommendation engine 112 determines the location information associated with the product purchaser profiles 124 and mobile device profile 202 do not match, then the product is not compatible (e.g., “No” from 306).

At 308, if the compatible product is identified then product-related data is extracted for use in generating the recommendation list. For example, the product recommendation engine 112 can extract information from the product purchaser profiles 124, such as location information, and the product feedback 130, such as associated with the compatible products 116.

At 310, the compatible product is added to the positive product list. For example, the product recommendation engine 112 generates the positive product list 212 with each compatible product 116. At 312, if the product is not compatible, a determination is made whether the product has been returned. For example, the product recommendation engine 112 may determine a product was returned based on the product feedback 130 which includes returned products 208 (e.g., “No” from 312).

At 314, a determination is made as to whether the reason for return is incompatibility. For example, the product recommendation engine 112 may determine that the reason for return is the product is incompatible from the product feedback 130 associated with the returned products 208 (e.g., “Yes” from 316). At 316, if the product is determined incompatible, then product-related data is extracted. For example, the product recommendation engine 112 can extract information from the product purchaser profiles 124 and the product feedback 130 associated with the incompatible product. At 318, the incompatible product is added to the negative product list. For example, the product recommendation engine 112 generates the negative product list 214 with each incompatible product.

At 320, a recommendation list of compatible products is generated. For example, the product recommendation engine 112 can compare the negative product list to the positive product list and filter out products based on the search input 118. Through the filtering process, the product recommendation engine 112 identifies compatible products 116. The compatible products may be compiled into the recommendation list for display on the e-commerce webpage 132.

At 322 a search input is received for a product. For example, the product recommendation manager 110 receives the search input 118 and the mobile device 102 communicates the search input 118 over the network 106 to the product recommendation engine 112 of the server device 104. At 324, a determination is made as to whether there is a recommendation for compatible products. For example, the product recommendation engine 112 can receive the search input 118 for the consumer product and identify compatible products. The product recommendation engine 112 can generate the recommendation list if compatible products are identified (e.g, “Yes” from 324).

At 326, a compatible products recommendation is displayed. For example, the product recommendation engine 112 can generate the recommendation list 114 and communicate (e.g., or cause the server device to communicate) the recommendation list 114 over the network 106 to the mobile device 102. The recommendation list 114 can be displayed on the e-commerce webpage 132 on the display device of the mobile device 102 for the consumer to view and obtain information about the compatible products that are available on the e-commerce webpage for purchase.

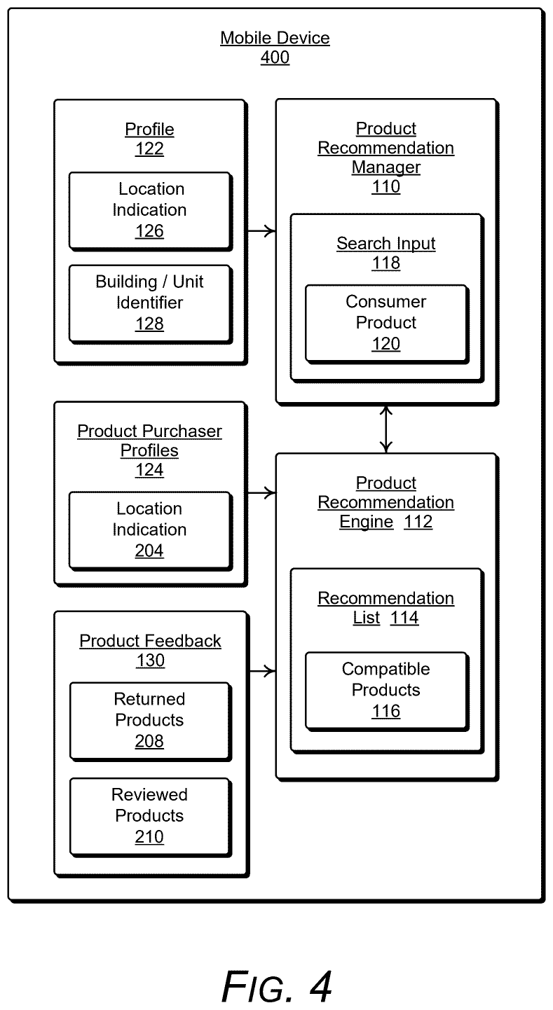

FIG. 4 illustrates an example device 400, which can be used to implement aspects of the techniques for compatible product recommendations, as described herein. Generally, the example device 400 is a mobile device, similar to the mobile device 102 which can be utilized to implement the features and techniques of compatible product recommendations, such as shown and described with reference to FIG. 1. However, in this example, the mobile device 400 implements both the product recommendation manager 110 and the product recommendation engine 112. The product recommendation manager 110 can receive a search input 118 for a consumer product, such as shown and described with reference to FIG. 1. The product recommendation manager 110 may determine a profile 122 associated with the mobile device 400 in response to receiving the search input 118.

In implementations of compatible product recommendations, as described herein, the search input 118 is received by the product recommendation engine 112 (e.g., from the product recommendation manager 110). The product recommendation engine 112 generates the recommendation list 114 which includes the compatible products 116. The product recommendation engine 112 may generate the recommendation list 114 based on the search input 118, the profile 122 associated with the mobile device 400, product purchaser profiles 124, and product feedback 130. The product feedback 130 may include product reviews, ratings, reasons for returns, and/or any other product comments, as described with reference to FIG. 1. Additionally, the product recommendation engine 112 can sort through the product feedback 130, display relevant comments associated with the compatible products 116, and extract product ratings to display highly rated compatible products 116, such as shown and described with reference to FIG. 1

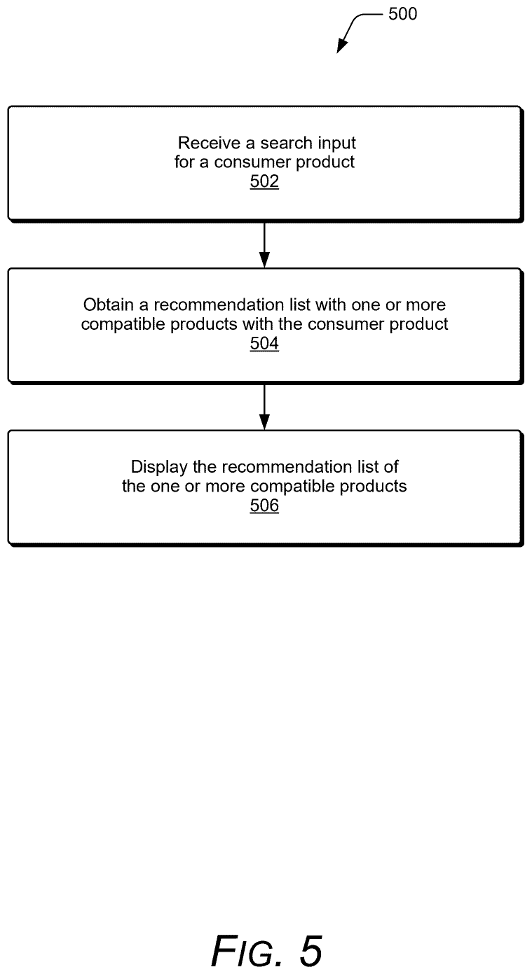

Example methods 500, 600, and 700 are described with reference to respective FIGS. 5, 6, and 7 in accordance with one or more implementations of compatible product recommendations, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 5 illustrates example method(s) 500 for compatible product recommendations. The order in which the method is described is not intended to be construed as a limitation, and any number or combination of the described method operations may be performed in any order to perform a method, or an alternate method.

At 502, a search input is received for a consumer product. For example, the product recommendation manager 110 implemented by the mobile device 102 receives the search input 118 for the consumer product 120. In implementations, an input from a person (e.g., a consumer) who is searching for a product that requires compatibility with an installation location may enter the search input 118 on a user interface of an e-commerce webpage to be received by the product recommendation manager.

At 504, a recommendation list is obtained with one or more compatible products with the consumer product. For example, the product recommendation manager 110 obtains the recommendation list 114 from the product recommendation engine 112, such as communicated over the network 106 from the server device 104 to the mobile device 102. The product recommendation engine 112 at the server device 104 generates the recommendation list 114 of the compatible products 116, which may be compatible models, brands, manufacturers, different years of manufacturer, different versions, types, designs, variety, etc., that will satisfy installation, fitment, and/or operational compatibility for a consumer.

At 506, the recommendation list of the one or more compatible products is displayed. For example, the product recommendation manager 110 at the mobile device 102 initiates to display the recommendation list 114 on the user interface 134 of the display device of the mobile device 102 for the consumer to view and obtain information about compatible products available on the e-commerce webpage for purchase.

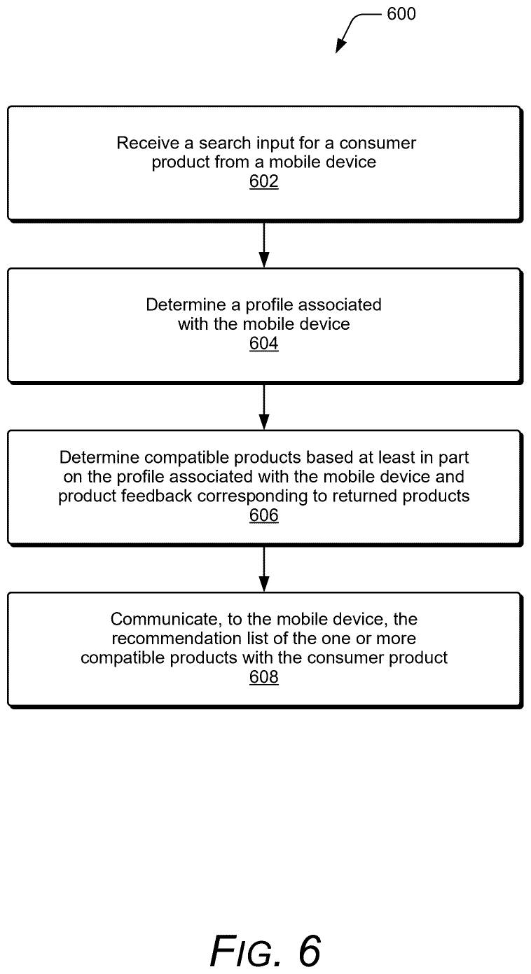

FIG. 6 illustrates example method(s) 600 for compatible product recommendations. The order in which the method is described is not intended to be construed as a limitation, and any number or combination of the described method operations may be performed in any order to perform a method, or an alternate method.

At 602, a search input for a consumer product is received from a mobile device. For example, the product recommendation engine 112 implemented by the server device 104 receives the search input 118 over the network 106 from the mobile device 102. In implementations, an input from a person (e.g., a consumer) who is searching for a product that requires compatibility with an installation location may enter the search input 118 in the user interface of an e-commerce webpage, and the search input 118 is then communicated to the server device 104 and received by the product recommendation engine 112.

At 604, a profile associated with the mobile device is determined. For example, the product recommendation engine 112 determines the mobile device profile 202 in response to receiving the search input 118 from the mobile device 102. In implementations, the mobile device profile information associated with a consumer (e.g., a user of the mobile device) may be used to identify other consumers who have searched for and/or purchased similar products to the search input.

At 606, compatible products based at least in part on the profile associated with the mobile device and product feedback corresponding to returned products is determined. For example, the product recommendation engine 112 determines the compatible products 116 based on the mobile device profile 202, the product feedback 130, and/or returned products 208 by comparing profile information and sorting through the product feedback to identify compatible products, which may be compatible models, brands, manufacturers, different years of manufacturer, different versions, types, designs, variety, etc., that will satisfy installation, fitment, and/or operational compatibility for a consumer.

At 608, the recommendation list of the one or more compatible products with the consumer product is communicated to the mobile device. For example, the product recommendation engine 112 determines the compatible products 116 and generates the recommendation list 114 with the compatible products 116. The product recommendation engine 112 communicates (or causes the server device 104 to communicate) the recommendation list 114 over the network 106 to the mobile device 102 for the consumer to view and obtain information about the compatible products 116 that are available on the e-commerce webpage for purchase.

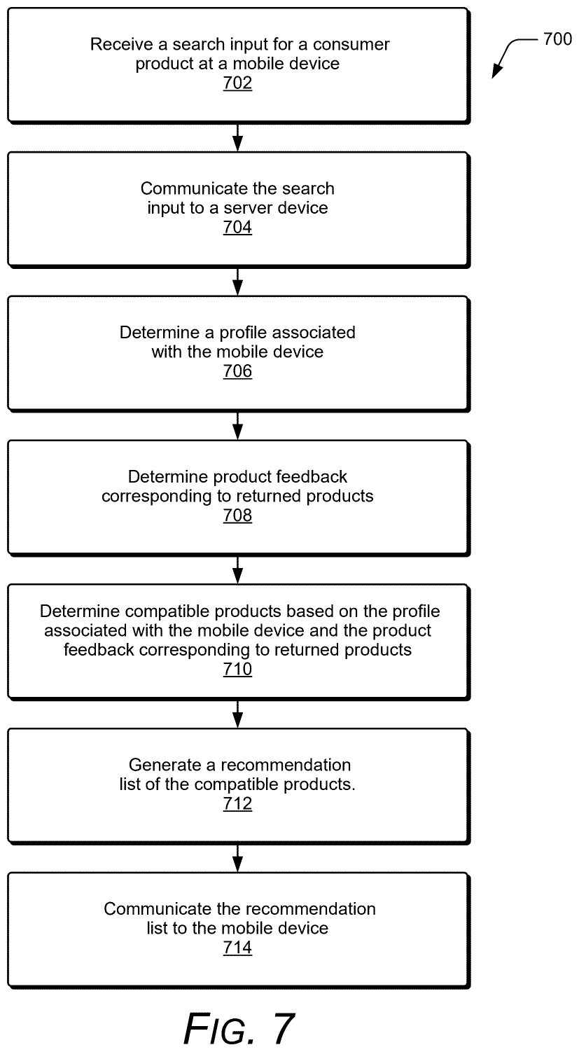

FIG. 7 illustrates example method(s) 700 for compatible product recommendations. The order in which the method is described is not intended to be construed as a limitation, and any number or combination of the described method operations may be performed in any order to perform a method, or an alternate method.

At 702, a search input for a consumer product is received at a mobile device. For example, the product recommendation manager 110 implemented by the mobile device 102 receives the search input 118 for the consumer product 120. In implementations, an input from a person (e.g., a consumer) who is searching for a product that requires compatibility with an installation location may enter the search input 118 on a user interface of an e-commerce webpage to be received by the product recommendation manager. At 704, the search input is communicated to a server device. For example, the mobile device 102 communicates the search input 118 over the network 106 to the server device 104, and the product recommendation engine 112 receives the search input 118.

At 706, a profile associated with the mobile device is determined. For example, the product recommendation engine 112 determines the mobile device profile 202 in response to receiving the search input 118. In implementations, the mobile device profile information associated with the consumer (e.g., a user of the mobile device) may be used to identify other consumers who have searched for and/or purchased similar products to the search input.

At 708, product feedback corresponding to returned products is determined. For example, the product recommendation engine 112 determines the product feedback 130 corresponding to returned products 208, which may be products that were not retained by the product purchaser for any number of reasons, including the product does not fit, different types of connections, connection location is improper, and/or any other reason the product is incompatible for use by the consumer.

At 710, compatible products are determined based on the profile associated with the mobile device and the product feedback corresponding to returned products. For example, the product recommendation engine 112 determines the compatible products 116 based on the mobile device profile 202, the product feedback 130, and/or the returned products 208 by comparing profile information and sorting through the product feedback to identify the compatible products, which may be compatible models, brands, manufacturers, different years of manufacturer, different versions, types, designs, variety, etc., that will satisfy installation, fitment, and/or operational compatibility for a consumer.

At 712, a recommendation list of the compatible products is generated. For example, the product recommendation engine 112 compiles the recommendation list 114 of the compatible products 116. At 714, the recommendation list of the compatible products is communicated to the mobile device. For example, the product recommendation engine 112 communicates (or causes the server device 104 to communicate) the recommendation list 114 over the network 106 to the mobile device 102 for display in the e-commerce webpage on the mobile device for the consumer to view and obtain information about the compatible products 116 that are available for purchase.

FIG. 8 illustrates various components of an example device 800, which can implement aspects of the techniques and features for compatible product recommendations, as described herein. The example device 800 may be implemented as any of the devices described with reference to the previous FIGS. 1-7, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 102 and/or the server device 104 described with reference to FIGS. 1-7 may be implemented as the example device 800.

The example device 800 can include various, different communication devices 802 that enable wired and/or wireless communication of device data 804 with other devices. The device data 804 can include any of the various devices data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The I/O interfaces 806 may be used to couple the device to any type of components, peripherals, and/or accessory devices, such as a computer input device that may be integrated with the example device 800. The I/O interfaces 806 may also include data input ports via which any type of data, information, media content, communications, messages, and/or inputs may be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 may be maintained as software instructions with a memory device 812 and executed by the processor system 808 as a software application. The device applications 814 may also include a device manager, such as any form of a control application, software application, signal-processing and control module, code that is specific to a particular device, a hardware abstraction layer for a particular device, and so on.

In this example, the device 800 includes a product recommendation manager 818 that implements various aspects of the described features and techniques described herein. The product recommendation manager 818 may be implemented with hardware components and/or in software as one of the device applications 814, such as when the example device 800 is implemented as the mobile device 102 described with reference to FIGS. 1-7. An example of the product recommendation manager 818 is the product recommendation manager 110 implemented by the mobile device 102, such as a software application and/or as hardware components in the mobile device. In implementations, the product recommendation manager 818 may include independent processing, memory, and logic components as a computing and/or electronic device integrated with the example device 800.

In this example, the device 800 includes a product recommendation engine 820 that implements various aspects of the described features and techniques described herein. The product recommendation engine 820 may be implemented with hardware components and/or in software as one of the device applications 814, such as when the example device 800 is implemented as the server device 104 described with reference to FIGS. 1-7. An example of the product recommendation engine 820 is the product recommendation engine 112 implemented by the server device 104, such as a software application and/or as hardware components in the mobile device. In implementations, the product recommendation engine 820 may include independent processing, memory, and logic components as a computing and/or electronic device integrated with the example device 800.

The example device 800 can also include a microphone 822 (e.g., to capture an audio recording of a user) and/or camera devices 824 (e.g., to capture video images of the user during a call), as well as motion sensors 826, such as may be implemented as components of an inertial measurement unit (IMU). The motion sensors 826 may be implemented with various sensors, such as a gyroscope, an accelerometer, and/or other types of motion sensors to sense motion of the device. The motion sensors 826 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 828, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 800 can also include an audio and/or video processing system 830 that generates audio data for an audio system 832 and/or generates display data for a display system 834. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 800. Alternatively, the audio system and/or the display system are external, peripheral components to the example device.

Although implementations for compatible product recommendations have been described in language specific to features and/or methods, the appended claims are not necessarily limited to the specific features or methods described. Rather, the specific features and methods are disclosed as example implementations for compatible product recommendations, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising: at least one processor coupled with a memory; and a product recommendation manager implemented at least partially in hardware and configured to cause the mobile device to: receive a search input for a consumer product; receive a recommendation list of one or more compatible products with the consumer product, the one or more compatible products determined based at least in part on a profile associated with the mobile device and product feedback corresponding to returned products; and display the recommendation list of the one or more compatible products on a display device.

Alternatively, or in addition to the above-described mobile device, any one or combination of: the product recommendation manager is configured to cause the mobile device to communicate the search input for the consumer product to a product recommendation engine, and receive the recommendation list from the product recommendation engine. The product recommendation engine is implemented by at least one of the mobile device or a server device. The product recommendation engine is configured to search and filter the product feedback from at least one or more product purchasers of the consumer product to generate the recommendation list. The product recommendation engine is configured to compare at least a location indication in the profile associated with the mobile device to a product purchaser location associated with one or more of the product purchasers, and wherein the product purchaser location corresponds to a location of a user associated with the profile. The product recommendation manager is configured to cause the mobile device to display an e-commerce webpage with compatible models of the consumer product from the recommendation list based at least in part on the profile associated with the mobile device and the product feedback. The product feedback corresponding to the returned products includes at least one reason for return of the consumer product. The at least one reason for the return includes at least one indication of incompatibility.

A method, comprising: receiving, at a mobile device, a search input for a consumer product; obtaining a recommendation list of one or more compatible products with the consumer product, the one or more compatible products determined based at least in part on a profile associated with the mobile device and product feedback corresponding to returned products; and displaying the recommendation list of the one or more compatible products on a display device.

Alternatively, or in addition to the above-described method, any one or combination of: communicating the search input for the consumer product to a product recommendation engine; and receiving the recommendation list from the product recommendation engine. Filtering the product feedback from at least one or more product purchasers of the consumer product to generate the recommendation list. Comparing at least a location indication in the profile associated with the mobile device to a product purchaser location associated with one or more of the product purchasers, and wherein the product purchaser location corresponds to a location of a user associated with the profile. Displaying an e-commerce webpage with compatible models of the consumer product from the recommendation list based at least in part on the profile associated with the mobile device and the product feedback. The product feedback corresponding to the returned products includes at least one reason for return of the consumer product. The at least one reason for the return includes at least one indication of incompatibility.

A server device, comprising: a product recommendation engine configured to generate a recommendation list of one or more compatible products with a consumer product; and a processor coupled with a memory, the processor configured to cause the server device to: receive a search input for the consumer product from a mobile device; determine a profile associated with the mobile device; determine the one or more compatible products based at least in part on the profile associated with the mobile device and product feedback corresponding to returned products; and communicate, to the mobile device, the recommendation list of the one or more compatible products with the consumer product.

Alternatively, or in addition to the above-described system, any one or combination of: the product recommendation engine is configured to search and filter the product feedback from at least one or more product purchasers of the consumer product to generate the recommendation list. The product recommendation engine is configured to compare at least a location indication in the profile associated with the mobile device to a product purchaser location associated with one or more of the product purchasers, and wherein the product purchaser location corresponds to a location of a user associated with the profile. The product recommendation engine is configured to cause the mobile device to display an e-commerce webpage with compatible models of the consumer product from the recommendation list based at least in part on the profile associated with the mobile device and the product feedback. The product feedback corresponding to the returned products includes at least one reason for return of the consumer product

1. A mobile device, comprising:
at least one processor coupled with a memory; and
a product recommendation manager implemented at least partially in hardware and configured to cause the mobile device to:
receive a search input for a consumer product;
receive a recommendation list of one or more compatible products with the consumer product, the one or more compatible products determined based at least in part on a profile associated with the mobile device and product feedback corresponding to returned products; and
display the recommendation list of the one or more compatible products on a display device.

2. The mobile device of claim 1, wherein the product recommendation manager is configured to cause the mobile device to communicate the search input for the consumer product to a product recommendation engine, and receive the recommendation list from the product recommendation engine.

3. The mobile device of claim 2, wherein the product recommendation engine is implemented by at least one of the mobile device or a server device.

4. The mobile device of claim 2, wherein the product recommendation engine is configured to search and filter the product feedback from at least one or more product purchasers of the consumer product to generate the recommendation list.

5. The mobile device of claim 4, wherein the product recommendation engine is configured to compare at least a location indication in the profile associated with the mobile device to a product purchaser location associated with one or more of the product purchasers, and wherein the product purchaser location corresponds to a location of a user associated with the profile.

6. The mobile device of claim 1, wherein the product recommendation manager is configured to cause the mobile device to display an e-commerce webpage with compatible models of the consumer product from the recommendation list based at least in part on the profile associated with the mobile device and the product feedback.

7. The mobile device of claim 1, wherein the product feedback corresponding to the returned products includes at least one reason for return of the consumer product.

8. The mobile device as described in claim 7, wherein the at least one reason for the return includes at least one indication of incompatibility.

9. A method, comprising:
receiving, at a mobile device, a search input for a consumer product;
obtaining a recommendation list of one or more compatible products with the consumer product, the one or more compatible products determined based at least in part on a profile associated with the mobile device and product feedback corresponding to returned products; and
displaying the recommendation list of the one or more compatible products on a display device.

10. The method of claim 9, further comprising:
communicating the search input for the consumer product to a product recommendation engine; and
receiving the recommendation list from the product recommendation engine.

11. The method of claim 9, further comprising filtering the product feedback from at least one or more product purchasers of the consumer product to generate the recommendation list.

12. The method of claim 11, further comprising comparing at least a location indication in the profile associated with the mobile device to a product purchaser location associated with one or more of the product purchasers, and wherein the product purchaser location corresponds to a location of a user associated with the profile.

13. The method of claim 9, further comprising displaying an e-commerce webpage with compatible models of the consumer product from the recommendation list based at least in part on the profile associated with the mobile device and the product feedback.

14. The method of claim 9, wherein the product feedback corresponding to the returned products includes at least one reason for return of the consumer product.

15. The method as described in claim 14, wherein the at least one reason for the return includes at least one indication of incompatibility.

16. A server device, comprising:
a product recommendation engine configured to generate a recommendation list of one or more compatible products with a consumer product; and
a processor coupled with a memory, the processor configured to cause the server device to:
receive a search input for the consumer product from a mobile device;
determine a profile associated with the mobile device;
determine the one or more compatible products based at least in part on the profile associated with the mobile device and product feedback corresponding to returned products; and
communicate, to the mobile device, the recommendation list of the one or more compatible products with the consumer product.

17. The server device of claim 16, wherein the product recommendation engine is configured to search and filter the product feedback from at least one or more product purchasers of the consumer product to generate the recommendation list.

18. The server device of claim 16, wherein the product recommendation engine is configured to compare at least a location indication in the profile associated with the mobile device to a product purchaser location associated with one or more of the product purchasers, and wherein the product purchaser location corresponds to a location of a user associated with the profile.

19. The server device of claim 18, wherein the product recommendation engine is configured to cause the mobile device to display an e-commerce webpage with compatible models of the consumer product from the recommendation list based at least in part on the profile associated with the mobile device and the product feedback.

20. The server device of claim 16, wherein the product feedback corresponding to the returned products includes at least one reason for return of the consumer product.
